(19) United States
(12) Patent Application Publication
(10) Pub. No.: US 2021/0404301 A1
(43) Pub. Date: Dec. 30, 2021

(54) System for Remote Measurement of Ground Water Contamination Levels

(71) Applicant: Mohammed B. AlRayaan, Dammam (SA)

(72) Inventor: Mohammed B. AlRayaan, Dammam (SA)

(21) Appl. No.: 17/472,666

(22) Filed: Sep. 12, 2021

Related U.S. Application Data
(60) Provisional application No. 63/163,953, filed on Mar. 22, 2021.

(51) Int. Cl. E21B 43/12; E21B 41/06; E21B 47/13; E21B 21/06; B64C 39/02

(52) U.S. Cl. CPC E21B 43/121; E21B 41/06; B64C 2201/12; E21B 21/06; B64C 39/024; E21B 47/13

(57) ABSTRACT

The present disclosure provides a system and related methods for adapting groundwater monitoring wells and providing specially adapted aerial drones, with the adapted drones interacting with the modified monitoring wells to allow remote and even automated collection of ground water samples and/or data. The drones can be adapted either by provision of a contamination sensor or by carrying a payload of sample storage containers, and the monitoring wells can be configured to detect the approach of a drone and open automatically, or to have an injection point or even a matching sensor.

### CROSS-REFERENCE TO RELATED APPLICATIONS

The present application claims the benefit and priority of U.S. provisional application No. U.S. 63163953 filed 22 Mar. 2021, the contents of which is incorporated by reference.

### FIELD OF INVENTION

The present invention relates generally to the field of ground water sampling. More specifically, the present invention relates to modifications to groundwater monitoring wells and a specially adapted drone for taking sample collections or sensor readings of contamination levels at the modified wells.

### BACKGROUND

Advancements in drone technology have seen the development of drone-assisted water sampling payloads resulting in the ability of drones to retrieve water samples and physico-chemical data from aquatic ecosystems. These advancements include the development of drone platforms; advances in specially designed water sampling payloads; advances in incorporating off-the-shelf probes and the ability of drone-assisted water sampling payloads to capture water and physico-chemical data from freshwater environments.

The application of drones for water sampling provides the potential to fulfil many aspects of the biological and physico-chemical sampling required to meet large-scale water sampling programmes.

For example, the application of such technology to remote monitoring of water contamination levels at groundwater monitoring wells in areas of the world that are difficult or dangerous to access would reduce risk to personnel that would otherwise be carrying out such operations and provide significant resource optimization. Saudi Arabia is one such area that has a large number of such monitoring wells scattered across vast and often inaccessible terrain.

It is within this context that the present invention is provided.

### SUMMARY

The present disclosure provides a system and related methods for adapting groundwater monitoring wells and providing specially adapted aerial drones, with the adapted drones interacting with the modified monitoring wells to allow remote and even automated collection of ground water samples and/or data. The drones can be adapted either by provision of a contamination sensor or by carrying a payload of sample storage containers, and the monitoring wells can be configured to detect the approach of a drone and open automatically, or to have an injection point or even a matching sensor.

Thus, according to one aspect of the present disclosure there is provided a system for automated ground water sampling, the system comprising: an aerial drone, the aerial drone comprising: a means of aerial propulsion; a power unit; a wireless communications unit; a sensor for detecting a contamination level and related data at a ground water monitoring well; and an onboard processor configured to navigate the drone autonomously or according to instructions received via the wireless communications unit and to process readings received from the sensor.

The system further comprises a groundwater monitoring well having a modified cab to facilitate the sensor reading.

In some embodiments, the monitoring well cab is modified by having an electrical system at the opening configured to detect the approach of a drone and in response to such a detection to open and allow the drone inside to take readings using its own sensor.

In some embodiments, the monitoring well cab is modified by having its own contamination sensor in physical contact with a flow of ground water and which is connected to a reader at the opening of the well shaft, and wherein the reader is configured to communicate contamination readings to the drone sensor wirelessly.

In some embodiments, the processor is further configured to transmit the contamination data to an external device via the wireless communications unit.

According to another aspect of the present disclosure, there is provided a system for automated ground water sampling, the system comprising: an aerial drone, the aerial drone comprising: a means of aerial propulsion; a power unit; a wireless communications unit; one or more sample storage containers; a groundwater sample collection needle comprising an electrical pump; and an onboard processor configured to navigate the drone autonomously or according to instructions received via the wireless communications unit and to control the electric pump to fill one or more of the sample storage containers from a groundwater monitoring well.

The system further comprises a groundwater monitoring well having a modified cab to facilitate the sample collection.

In some embodiments, the monitoring well cab is modified by having an electrical system at the opening configured to detect the approach of a drone and in response to such a detection to open and allow the drone inside to take samples using its collection needle.

In some embodiments, the monitoring well cab is modified to provide a raised water level and a small opening or injection point for receiving the needle tip.

### BRIEF DESCRIPTION OF THE DRAWINGS

Various embodiments of the invention are disclosed in the following detailed description and accompanying drawings.

FIG. 1 illustrates a first example configuration of a system according to the present disclosure including an aerial drone equipped with a sensor and a modified ground water monitoring well (not to scale).

FIG. 2 illustrates the first example configuration of the system to scale after the monitoring well has detected the drone and opened its cab.

FIG. 3 illustrates a second example configuration of a system according got the present disclosure wherein a drone has been equipped with a sample collection needle and one or more sample storage containers, furthermore the ground monitoring well has been adapted to allow easy collection of groundwater by the needle.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

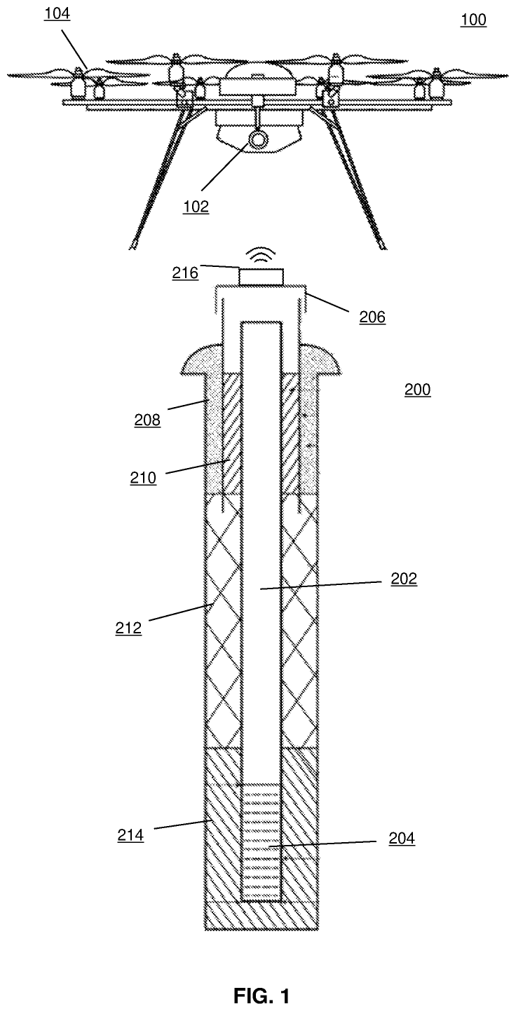

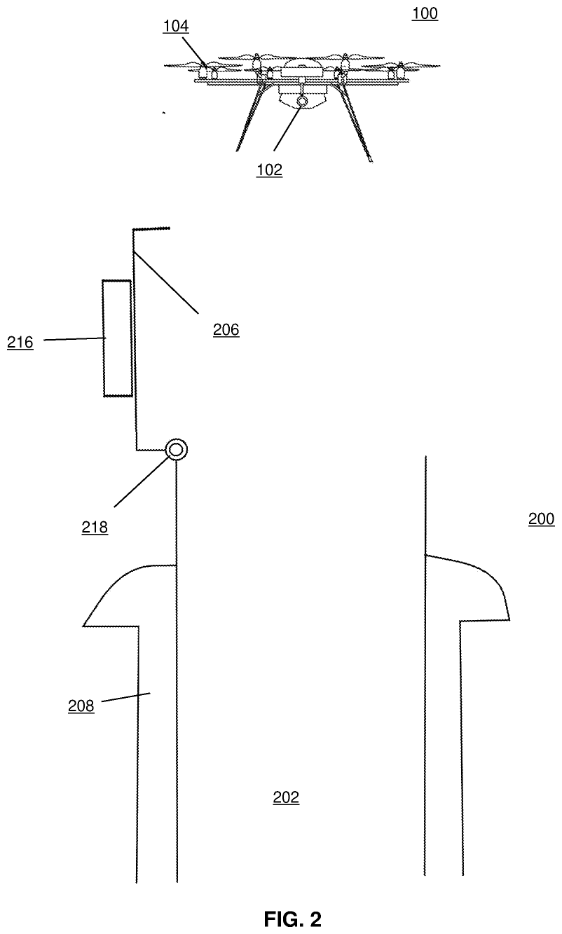

Referring to FIG. 1, a first example configuration of a system according to the present disclosure is shown including an aerial drone 100 equipped with a sensor 102 and a modified ground water monitoring well 200 (not to scale, in practice the drone is much smaller relative to the size of the monitoring well with sufficient diameter for the drone to enter the well as shown in FIG. 2).

The aerial drone 100 can be any off the shelf aerial drone including a means of propulsion such as propellers 104, and an onboard processor and wireless communications unit for navigating the drone to a groundwater monitoring well and receiving and transmitting data.

The drone 100 is then adapted for the task of measuring the contamination level of water at various ground water monitoring wells. In the present example this is achieved using a sensor 102 which can be lowered into the water for measurement when the drone is in the well shaft.

The monitoring well 200 is shown in cross sectional view and has a standard format. A standard monitoring well comprises a long shaft 202 surrounded by walls formed of several protective layers and which reaches down to a flow of groundwater 204. The top of the shaft is covered by a cab or casing 206 which is lockable and vented and which controls access to the well shaft 202.

The top portion of the shaft is at ground level and may be housed in a protective concrete shell 208 with a draining layer 210 such as grout on the inner surface of the shaft. Below this there is a section of shaft 212 formed of an impermeable layer of material such as bentonite, and below that is a filter section 214 which allows the groundwater to well up from the flow.

Thus, in a typical ground water monitoring well, the actual level of water is quite far down the shaft from the surface cab and would be difficult for a drone to reach since it cannot open the heavy cab 206 itself.

The well cab 206 itself is thus also adapted with a sensor 216 which detects that a drone is approaching, either by wireless communication with the drone 100 or by actual physical detection of proximity of the drone.

The cab 206 is further fitted with an electric motor or other mechanism for opening in response to the detection.

Referring to FIG. 2, the monitoring well 200 now drawn to scale is shown to have detected the drone 100 and opened its cab 100 using electric motor 218.

This is merely one example configuration of how the cab could provide water access for the drone and the skilled person will recognise that various other mechanisms could be used that would still fall within the scope of the present disclosure. The innovative concept is detecting the approach of the drone and having a mechanism in place in the cab for allowing the drone access to measure (or collect) a water sample.

Once the drone 100 has taken sensor readings of the water within the monitoring well, it can log these readings and wirelessly transmit them to an external device for processing. Optionally, the drone 100 can then move on to another remote ground water monitoring well.

In another embodiment, the drone 100 is equipped with a sample collection needle 106 and pump and several water sample storage containers which can be filled via the needle 106 and pump. In such embodiments the drone collects water samples from the wells and physically returns the samples to a laboratory for detailed analysis, rather than attempting to detect a contamination level itself using a sensor.

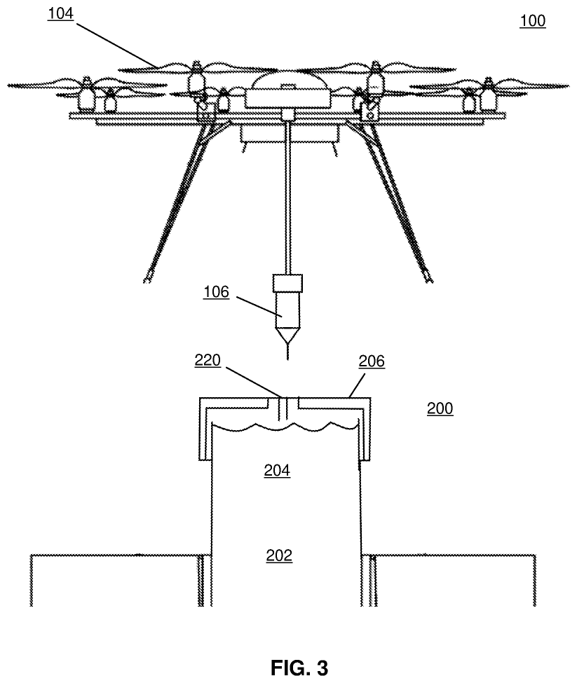

Referring to FIG. 3, this second example configuration is shown with the drone 100 equipped with a sample collection needle 106 and one or more sample storage containers.

Furthermore, rather than being configured to detect the approach of the drone 100 and open, the ground monitoring well 200 has been adapted to allow easy collection of groundwater by the needle 206 by raising the water level and providing a soft needle insertion point 220.

A drone modified as shown in FIG. 3 could work equally well with the monitoring well configuration shown in FIG. 2, the alternative mechanism shown in FIG. 3 is merely to illustrate that opening of the cab 206 is not the only way to adapt a monitoring well to facilitate collection.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for remote ground water contamination level monitoring have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for automated ground water sampling, the system comprising:
an aerial drone, the aerial drone comprising:
a means of aerial propulsion;
a power unit;
a wireless communications unit;
a sensor for detecting a contamination level and related data at a ground water monitoring well; and
an onboard processor configured to navigate the drone autonomously or according to instructions received via the wireless communications unit and to process readings received from the sensor;
the system further comprising:
a groundwater monitoring well having a modified cab to facilitate the sensor reading.

2. A system according to claim 1, wherein the monitoring well cab is modified by having an electrical system at the opening configured to detect the approach of a drone and in response to such a detection to open and allow the drone inside to take readings using its own sensor.

3. A system according to claim 1, wherein the monitoring well cab is modified by having its own contamination sensor in physical contact with a flow of ground water and which is connected to a reader at the opening of the well shaft, and wherein the reader is configured to communicate contamination readings to the drone sensor wirelessly.

4. A system according to claim 1 wherein the processor is further configured to transmit the contamination data to an external device via the wireless communications unit.

5. A system for automated ground water sampling, the system comprising:
an aerial drone, the aerial drone comprising:
a means of aerial propulsion;
a power unit;
a wireless communications unit;
one or more sample storage containers;
a groundwater sample collection needle comprising an electrical pump; and
an onboard processor configured to navigate the drone autonomously or according to instructions received via the wireless communications unit and to control the electric pump to fill one or more of the sample storage containers from a groundwater monitoring well;
the system further comprising:
a groundwater monitoring well having a modified cab to facilitate the sample collection.

6. A system according to claim 5, wherein the monitoring well cab is modified by having an electrical system at the opening configured to detect the approach of a drone and in response to such a detection to open and allow the drone inside to take samples using its collection needle.

7. A system according to claim 5, wherein the monitoring well cab is modified to provide a raised water level and a small opening or injection point for receiving the needle tip.
